(19) United States
(12) Patent Application Publication
(10) Pub. No.: US 2012/0095804 A1
(43) Pub. Date: Apr. 19, 2012

(54) SALES OPTIMIZATION SYSTEM

(75) Inventors: James Calabrese, Paoli, PA (US); John Hoeller, Basking Ridge, NJ (US); Marc A. Sotkiewicz, Chicago, IL (US)

(73) Assignee: Accenture Global Services Limited, Dublin (IE)

(21) Appl. No.: 13/211,014

(22) Filed: Aug. 16, 2011

Related U.S. Application Data
(60) Provisional application No. 61/374,114, filed on Aug. 16, 2010.

(51) Int. Cl. G06Q 10/04

(52) U.S. Cl. 705/7.31

(57) ABSTRACT

A sales optimization system includes a forecasting module to determine forecasts for sales metrics, an optimization module to determine recommended actions for achieving sales goals, and a user interface to generate scorecards indicating actual vales for the sales metrics, forecasts for the sales metrics, and the recommended actions to improve the sales metrics. The forecasting module determines quantifications for forecasting variables, and the forecasts are determined based on the forecasting variables. The optimization module determines factors estimated to have impacted the sales metrics, and the recommended actions based on the factors.

### PRIORITY

The present application claims priority to U.S. provisional patent application Ser. No. 61/374,114, filed Aug. 16, 2010 and entitled “High Performance Selling Optimization System”, which is incorporated by reference in its entirety.

### BACKGROUND

For traditional brick and mortar retailers, their sales force plays a key role in driving sales. As a result, many retailers provide training for their sales associates and many implement bonus-based compensation that is adjusted based on completed sales to incentivize their sales force. These type of conventional techniques may be a good starting point, however, reliance on these conventional techniques alone may not necessarily improve sales over a competitor. For example, studies have shown that 80% of the sales force only brings in 42% of the revenue. The top 20% of the sales force brings in 58% of the revenue. Typical training and bonus-based compensation have not changed these facts, and do not address why these facts are true and how to improve the bottom 80% of the sales force to achieve the sales results of the top 20%.

Another facet to improving a sales force is related to forecasting and budgeting. Many retailers forecast their sales for the next quarter or even for the next full year. They use these forecasts to determine budgets and make hiring and staffing decisions. For example, if a retailer determines that the next quarter sales are forecasted to be 10-20% higher than the same quarter one year ago, the retailer may increase the human resources budget so more sales associates can be hired.

In many instances, the sales forecasts are inaccurate. This can result in unnecessary hiring or inadequate hiring and lost profits. For example, if sales forecasts are inaccurate on the high side but additional sales associates were already hired, then the salary of the unnecessary sales associates increases overhead and reduces profits. On the other hand, if sales forecasts are inaccurate on the low side and the sales force was reduced, then there may not be sufficient sales associates to drive sales that should be made. Accordingly, inaccurate forecasting is problematic.

### BRIEF DESCRIPTION OF DRAWINGS

The embodiments of the invention will be described in detail in the following description with reference to the following figures.

FIG. 1 illustrates a selling optimization system, according to an embodiment;

FIG. 2 illustrates a flow chart of a method, according to an embodiment, which may be implemented to optimize selling performance;

FIG. 3 illustrates a method for determining forecasts for metrics, according to an embodiment;

FIGS. 4A-B show examples of information that may be provided in a dashboard as a daily report, according to an embodiment;

FIG. 5 illustrates a method for determining the recommended actions, according to an embodiment;

FIGS. 6A-F illustrate examples of conditions and corresponding recommended actions, according to an embodiment; and

FIG. 7 illustrates a computing system that may be used as a computer hardware platform for the system shown in FIG. 1, according to an embodiment.

### DETAILED DESCRIPTION OF EMBODIMENTS

For simplicity and illustrative purposes, the principles of the embodiments are described by referring mainly to examples thereof. In the following description, numerous specific details are set forth in order to provide a thorough understanding of the embodiments. It will be apparent however, to one of ordinary skill in the art, that the embodiments may be practiced without limitation to these specific details. In some instances, well known methods and structures have not been described in detail so as not to unnecessarily obscure the embodiments. Also, the embodiments described herein may be used with each other in various combinations.

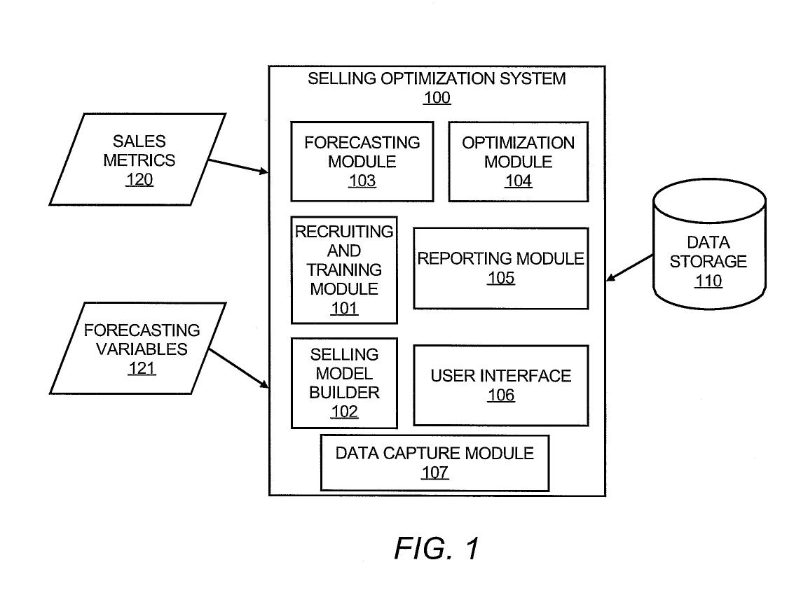

FIG. 1 illustrates a selling optimization system 100, according to an embodiment. The system 100 includes a recruiting and training module 101, a selling model builder module 102, a forecasting module 103, an optimization module 104, a reporting module 105, a user interface 106 and a data capture module 107. The modules and components of the system 100 may comprise software, hardware, or a combination of hardware and software. The system 100 may include a data storage 110. The data storage 110 may include a database or another conventional storage system that allows data to be stored and retrieved. The data storage 110 stores any data that may be used by the system 100. Some of this data includes sales metrics 120 and forecasting variables 121. The sales metrics 120 and forecasting variables 121 may be captured by point-of-sale systems and/or provided by other sources. The data capture module 107 may store the sales metrics 120 and forecasting variables 121 in the data storage 110. The data capture module 107 may include or interface with external data capture systems or other data sources to receive any data related to the sales metrics 120.

The sales metrics 120 include any metrics related to sales. The forecasting variables 121 include any variables that impact sales.

The selling model builder 101 generates a selling model, which is stored in the data storage 110. The selling model may specify guidelines for the sales force to generate sales. The selling model may identify the key stages of an effective sales process map, and provide processes for achieving each stage until a sale is made. The processes may specify guidelines for sales for each stage. For example, the processes may instruct sales associates to greet the customer on the sales floor, and ask open-ended questions to determine how they can help the customer. The processes may specify data capture processes to monitor metrics to measure performance, such as whether the sales associate is able to meet the customer's needs and offer additional items, or is the sales associate available for further questions. The monitored performance may be used as factors for determining recommended actions to maximize sales. Information from sales experts may be provided to the selling model builder 101, so the selling model can be generated.

The recruiting and training module 101 generates information to aid in identifying the best people to execute the selling model. For example, based on the selling model, attributes and traits for the sales force are identified that should be exhibited by candidates in order to be hired for a sales position.

Also, the recruiting and training module 101 provides training information for each sales position. This may include computer-based training for new hires, specific training for different positions, seasonal training for sales associates, product information, etc. The recruiting and, training module 101 may also generate information for training reinforcement. This may include tips for sales managers to run daily meetings and key performance indicators (KPIs) to discuss. Through the user interface 106, sales managers may enter management observations about the sales force and anything related to sales, which may be used for improving sales and the sales force, and evaluation of the sales associates. Information for a selling rewards program may also be tracked. These type of programs may be incentive-based programs that provide rewards to sales force employees based on their sales. Also, certification tests may be performed by an audit team and consequences are specified for non-compliance.

Data capture systems are used to capture sales data. These systems may include point-of-sale systems. The captured sales data, including the KPIs, may include the sales metrics 120 and the forecasting variables 121. Examples of the sales metrics 120 include actual number of visitors, actual conversion percentage, actual average order size, actual daily sales, and plus/minus versus sales goal ($). Conversion percentage, for example, is the number of customers that made a purchase divided by the total number of customers that entered the store or viewed goods or services online. Increasing this percentage should increase store revenue. The average order size may be computed by multiplying the average price per item (appi) by the number of items in the order or by dividing the sales by the number of customers. A sales associate can sell more items to a customer and/or sell the customer more expensive items to increase revenue.

The forecasting variables 121 may be variables that impact sales, such as competitor actions (e.g., whether a competitor is opening a new store in the vicinity or running a big dales), economic factors (e.g., inflation, unemployment, etc.), weather, etc. Other sources may provide the data for the forecasting variables 121. The forecasting module 103 may determine sales forecasts for one or more of the sales metrics 120 using the forecasting variables 121. The forecasting module 103 quantifies the forecasting variables 121 to estimate an amount of impact that the forecasting variables 121 will have on the sales metrics 120. Quantifying forecasting variables may include determining one or more ranges for each forecasting variable and using a subjective process to select a range or value for each forecasting variable. In one embodiment, a parametric procedure may be used to determine the distribution of a linear combination of skewed, yet independent, forecasting variables.

Using the quantifications, the forecasting module 103 forecasts the sales metrics 120, which may be used as goals. For example, the forecasting module 103 determines forecasted sales metrics 120 such as number of visitors, conversion percentage, average order size, and sales revenue. The forecasted sales metrics 120 are forecasted for a future time period, such as for a future day, week, month, quarter, year, etc. The quantification used to determine the forecasts may be based on an analysis of historic sales data and the forecasting variables. The forecasting allows for more accurate budgets and a more accurate determination of how much labor is needed for sales.

The optimization module 104 may determine whether a goal was missed by comparing the actual sales metrics to the goals. If a goal is missed, the optimization module 104 provides information to the user, such as a sales manager, that may educate why the goal was missed and how to achieve the goal. In an example, assume a targeted conversion percentage is missed. The optimization module 104 may identify causes, such as lack of inventory, failure to up-sell, competitor opening a new store, etc. These causes may be used to identify a solution to achieving the missed goal. In another example, traffic counters are used to improve performance. Peak traffic hours are determined from the historic sales metrics. The manager's effectiveness is assessed based on their hourly conversion. Optimal staffing levels are determined based on hourly conversion, sales per hour, and customer-to-staff ratios. In another example, the optimization module 104 maps certain forecasting variables 121 to each goal. If a goal is missed, the corresponding forecasting variables may be presented as potential causes.

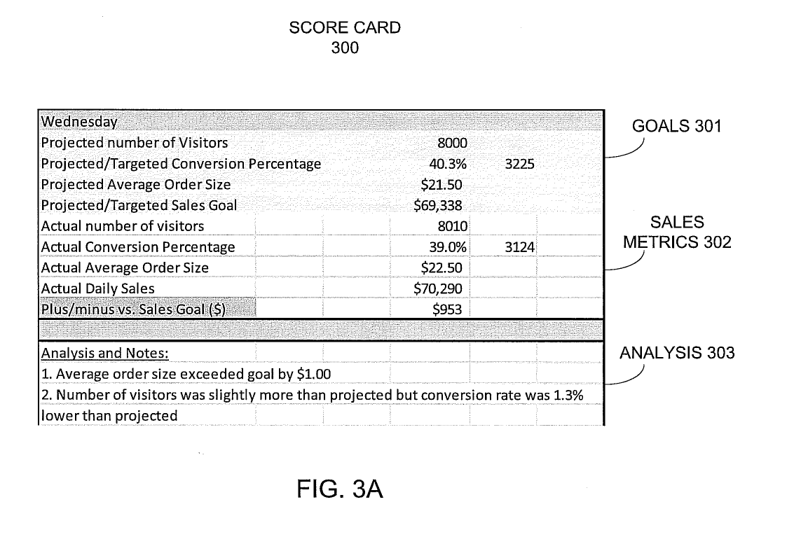

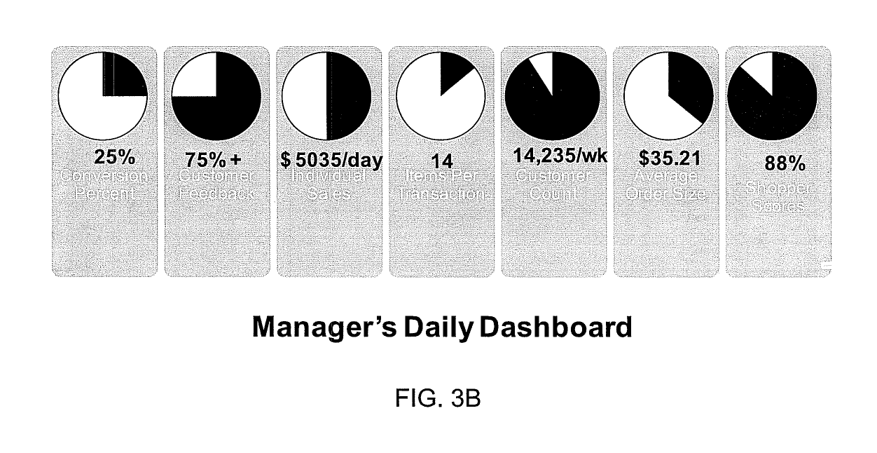

The reporting module 105 generates a scorecard through the user interface 106. The scorecard may include a daily scorecard identifying the sales metrics 120, goals, and reasons for missing goals and solutions and recommendations as determined by the optimization module 104. Examples of scorecards are shown in FIGS. 3A-B described below.

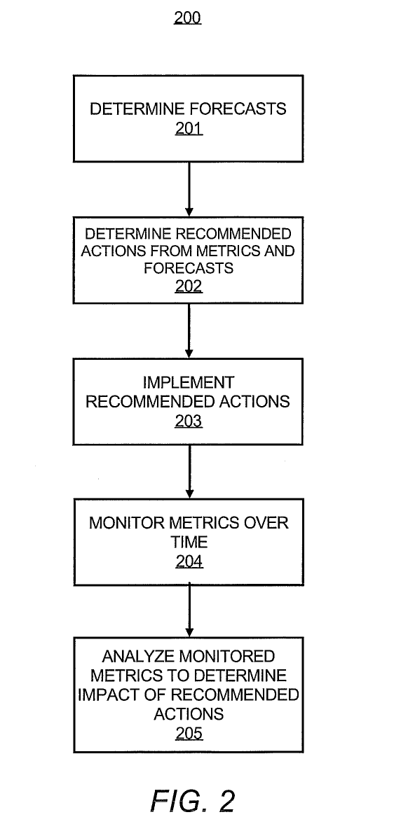

FIG. 2 illustrates a flowchart of a method 200, according to an embodiment, which may be implemented to optimize selling performance. It should be understood that the method 200 may include additional steps and that some of the steps described herein may be removed and/or modified without departing from a scope of the method 200. In addition, one or more steps of the method 200 and other methods described herein may be implemented by the system 100 shown in FIG. 1 by way of example, but may also be practiced in other systems.

At step 201, forecasts are determined, for example, by the forecasting module 103 shown in FIG. 1. The forecast are estimations of metrics, such as the sales metrics 120, for future time periods, such as future weeks, months, quarters, etc. The sales metrics 120 may include number of visitors, conversion percentage, average order size, dollars per transaction or other key performance indicators. A method 400 described below includes details for determining forecasts. Forecasts may be determined by historical analysis of sales metrics, human expert analysis, and by quantified forecasting variables.

At step 202, the actual metrics and the forecasts are analyzed to determine recommended actions to implement that are known to impact performance. The actual metrics may be captured by metric measuring systems or provided by other sources and stored in the data storage 110. The optimization module 104 shown in FIG. 1 may perform the analysis. The actual metrics may be measurements for the metrics for a current time period, whereby the forecasts may be estimations for the metrics made in the past for the current time period or estimations for future time periods. A recommended action may include an action performed to impact a metric. For example, recommended actions may include adjustments in selling, staffing and training. The action, for example, may be performed by a manager or sales employee. The action may include using computerized tools. For example, an action may include computerized training or coaching implemented by tools available to the sales force. The recruiting and training module 101 shown in FIG. 1 may include computerized training tools.

The actions may include motivational activities, such as bonus or reward programs, vendor contests, informal parties, and verbal acknowledgment of well performed jobs. Other types of actions may also be implemented.

In one embodiment, the analysis of the metrics in step 202 includes comparing the sales metrics 120 for a current time period to goals, which may include the forecasts for that time period or other goals, to determine whether the sales metrics satisfy or do not satisfy the goals. For example, a daily score card, such as shown in FIG. 3A, may be generated showing the sales metrics 120 for the current day or a previous day and the goals for that day. The daily score card may indicate if goals are met.

FIGS. 3A-B show examples of information that may be provided in a dashboard as a daily report. The reporting may also be presented for other time periods, such as weekly, monthly, etc. Also, the reporting provided via the dashboard is not limited to the information shown in FIGS. 3A-B. The dashboard and reporting may include a graphical user interface presented via the user interface 106 shown in FIG. 1.

FIG. 3A shows an example of a daily scorecard. The score card shows the day of the week, e.g., Wednesday, for which the data is representative. The score card 300 includes a goals section 301, a sales metrics section 302 and an analysis section 303. The goals section 301 indicates the goals, which may include the forecasts for the sales metrics. Examples of the goals as shown includes projected number of visitors, projected conversion percentage, projected average order size and projected total sales for the day. The sales metrics section 302 includes the sales metrics for that day, such as actual number of visitors, actual conversion percentage, actual average order size and actual total sales for that day. The analysis section 303 includes differences between the actual metrics in the section 302 and the goals in section 301. The analysis section may also identify reasons for the differences, which can be related to forecasting variables. The reasons may be based on competitive intelligence, economic variables, weather information, customer profiles, etc.

Recommended actions are selected, for example, based on the analysis presented in section 303 and other factors, such as demographics, seasons, etc. The recommended actions may be presented to the user in the dashboard via the user interface. Selecting recommended actions is further described below with respect to the method 500.

FIG. 3B shows an example of sales metrics that may also be presented via the dashboard in a graphical form. In this example, the graphical form is a pie chart. This information may be presented as daily metrics for a manager of a sales team. The sales metrics may include conversion percentage, percentage of positive customer feedback, individual sales (e.g., average or cumulative), items purchased per transaction, customer count of total customers that entered the store or viewed items for the time period, average order size in terms of dollars, and shopper scores. The shopper scores may be calculated for each shopper as a function items purchased for each transaction, number of transactions in a given period, demographics, etc. The metrics in this dashboard may represent the selling performance for an entire store or for a department. A manager may use the metrics to adjust sales team behavior and operations. Also, individually, sales associates can view conversion percentage and average order size to focus on improving these metrics.

Referring back to step 202, at this step the actual metrics and the forecasts are analyzed as described above. The analysis performed at step 202 may also include comparing the forecasts determined at step 201 to goals for the future time period. For example, if the forecasts indicate a decrease in number of transactions for the next quarter, and the goal is to increase the number of transactions by 5%, then recommended actions are identified to increase the number of transactions for the future period.

The recommended actions determined based on the analysis at step 302 are known to impact the forecasted metrics, for example, based on historic data analysis. For example, data from previous quarters is analyzed to determine whether a certain action or set of actions impacted the metrics. Based on the analysis, actions are identified that positively impacted the metrics. Also, actions can be tested using control groups to determine how they impact the metrics. For example, a particular action may be applied in one store and not in another store in the same geographic region. Then, the metrics from each store are compared to determine whether the action impacted the metric and whether the impact was positive, i.e., improved the metric such as increasing sales volume. Actions determined to improve the metrics may be stored as potential actions that can be recommended.

At step 203, the recommended actions are implemented, for example, by the sales force. A manager or other user may view the recommended actions presented by the system 100 via the user interface 106 and perform the actions. This may include changing staffing, implementing training and coaching, or performing other recommended actions.

At step 204, the metrics from the forecasts are monitored over time, including through the future period of time for which the forecasts were made. Monitoring may include capturing and storing the metrics, for example, through point-of-sale systems, customer tracking software and other systems. The captured data is stored in the data storage 110. The monitoring of the metrics may be considered as feedback to determine whether the recommended actions are improving the metrics, such as described at step 205.

At step 205, the monitored metrics are analyzed to determine whether goals were achieved and to determine the impact the recommended actions had on the metrics. Data may be continually captured and stored in the data storage 110. The optimization module 104 and experts may analyze the data to improve the understanding of why goals are missed and achieved and to determine the most effective recommendations to achieve goals. Based on this analysis and understanding, new actions may be recommended for certain situations if they are determined to have the greatest probability of positive impact for generating revenue or for achieving another objective.

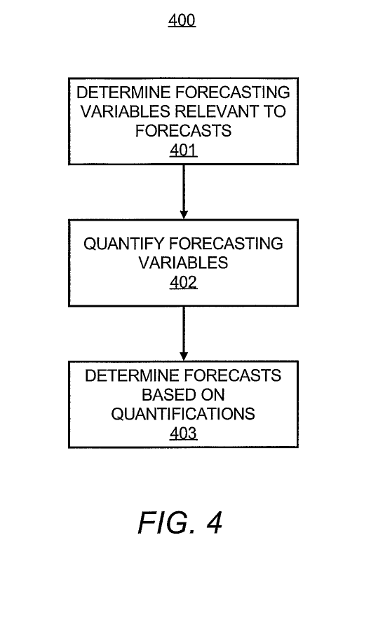

FIG. 4 illustrates a method 400 for determining forecasts for metrics, such as the sales metrics 120. The method 400 may be performed as sub-steps for step 201 of the method 200 to determine the forecasts at step 201. However, the forecasts of step 201 may be determined through other methods.

As indicated above, the forecasting variables 121 shown in FIG. 1 may be variables that impact sales. Examples of the forecasting variables 121 may include competitor actions (e.g., whether a competitor is opening a new store in the vicinity or running a large sale), economic factors (e.g., inflation, unemployment rate, etc.), weather, etc. The forecasting variables are independent of the sales metrics but may impact the sales metrics. At step 401, forecasting variables that are relevant to the forecasts are determined. In one embodiment, a set of forecasting variables may be predetermined for each store or customer based on the stores location, customer profiles, and other factors. For example, weather may not be considered as a forecasting variable for a store located in area where the weather is temperate throughout the year. In another example, if the customer profiles are more affluent for a particular store, then economic factors may not be considered as a forecasting variable or may be weighted less than other forecasting variables when determining the forecasts. A user may modify the relevant forecast variables as needed.

At step 402, the forecasting variables identified at step 401 are quantified. For example, the forecasting module 103 quantifies the forecasting variables 121 to estimate an amount of impact that the forecasting variables 121 will have on the sales metrics 120. The quantifying may include determining a quantification, which may include a measure of an estimation of amount of impact a forecasting variable has on a metric. The measure may be used to modify a forecast or a forecasting variable to quantify the forecast or forecasting variable. In one embodiment, quantifying forecasting variables may include determining one or more ranges for each forecasting variable and using a subjective process to select a range or value for each forecasting variable for a particular store or department.

For example, assume unemployment rate is an economic factor that is a forecasting variable for the sales revenue metric. Through regression analysis of historic sales data and unemployment rate, curves are generated plotting sales revenue and unemployment rate over time and relationships between the curves for historic sales data and unemployment rate are determined. These relationships characterize the impact that unemployment rate has on sales revenue for the particular store or department. For example, the relationships may indicate that as unemployment reaches a certain upper threshold, such as greater than 8.4%, then sales revenue may decrease between 2-4%. The forecasting module 103 may receive as input estimations of unemployment for next quarter, and based on the estimations, determines quantifications for the unemployment rate forecasting variable from the threshold and ranges. For example, if the estimations for the unemployment rate are greater than 8.4%, then the quantification may be determined to be a reduction in sales between 2-4%. In one example, the mean of 3% for the quantification range of 2-4% is selected. In another embodiment, the relevant forecasting variables are weighted based on their estimated impact on the metrics to provide the quantifications.

At step 403, the forecasting module 103 determines the forecasts for the sales metrics 120 based on the quantifications. For example, the forecasting module 103 determines estimations for sales metrics 120 such as number of visitors/customers, conversion percentage, average order size, and sales revenue for a future time period, such as for a future week, month, quarter, year, etc. Regression analysis of historic data for the metrics may be performed to determine the estimations. The quantifications for the forecasting variables are applied. This may include applying weightings or quantification ranges determined at step 402 to the forecasting variables or to estimations for the metrics. The forecasting allows for more accurate budgets and a more accurate determination of how much labor is needed for sales.

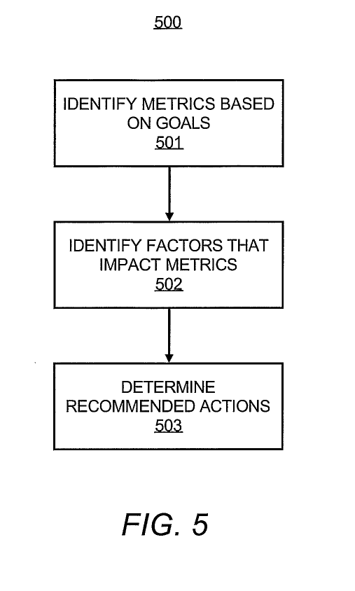

FIG. 5 illustrates a method 500 for determining the recommended actions to implement that are known to impact performance, according to an embodiment. The recommended actions may include the actions determined at step 202 of the method 200, and one or more of the steps of the method 500 may be performed as sub-steps for step 202 of the method 200. However, the recommended actions determined at step 202 may be determined through different methods.

At step 501, one or more metrics are identified based on goals. These may include one or more of the sales metrics 120 described above. In one example, the identified sales metrics may be selected because they fail to satisfy goals. Then, recommended actions can be presented to improve the metrics that did not satisfy the goals. The identified sales metrics may have forecasts, and the goals may include the forecasts determined for the sales metrics, such as shown in the score card 300 shown in FIG. 3A. Identifying metrics based on goals may also include identifying metrics that have met or exceeded their goals to determine explanations why the goals were exceeded. These explanations may then be used to improve metrics for other stores or products.

At step 502, factors are identified that are estimated to have impacted the one or more metrics are identified at step 501. The factors may include the goals from step 501 and factors estimated to have caused the metrics to not satisfy their respective goals or other thresholds. The factors may include forecasting variables that are determined to impact the identified metrics. Other factors may include store profiles, customer profiles, locations of the stores, locations of the customers, etc. For example, the data storage 110 may include a database storing relevant forecasting variables for each sales metric or for each location or customer profile. The optimization module 104 shown in FIG. 1 may query the data storage 110 for the relevant forecasting variables based on the identified metric, store location, customer profile and other factors.

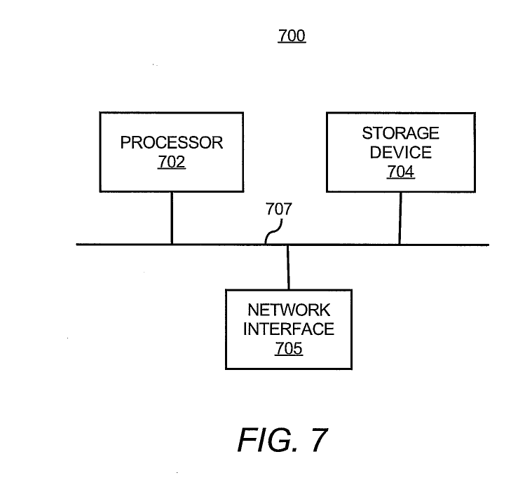

At step 503, recommended actions are determined based on the identified metrics from step 501 and/or the factors determined from step 502. For example, the optimization module 104 shown in FIG. 1 uses the factors for the identified metrics to determine potential causes why a metric failed to satisfy the goal. These factors may be used to identify recommended actions corresponding to the factors. For example, the data storage 110 may store mappings between factors and recommended actions. The optimization module 104 may query the data storage 110 for any recommended actions mapped to the factors. If a recommended action is retrieved that corresponds to one or more of the factors, then that recommended action may be presented to the user via the user interface. The stored mappings may include sets of multiple factors mapped to multiple actions. In one embodiment, if all the factors in a set are identified as related to a metric or metrics, then the corresponding recommended actions are retrieved, however, if only one or some of the set of factors are identified, then no match is of recommended actions are identified. Examples of sets of factors (e.g., referred to as conditions) and corresponding recommended actions are shown in FIGS. 7A-F. The conditions for recommended actions may be predetermined based on a historical analysis of the metrics and other related data or based on expert analysis and recommendations. Probabilities of achieving an outcome, such as improving a metric, may be derived for each recommended action, and the recommended actions with the highest probabilities may be presented to user via the user interface 105.

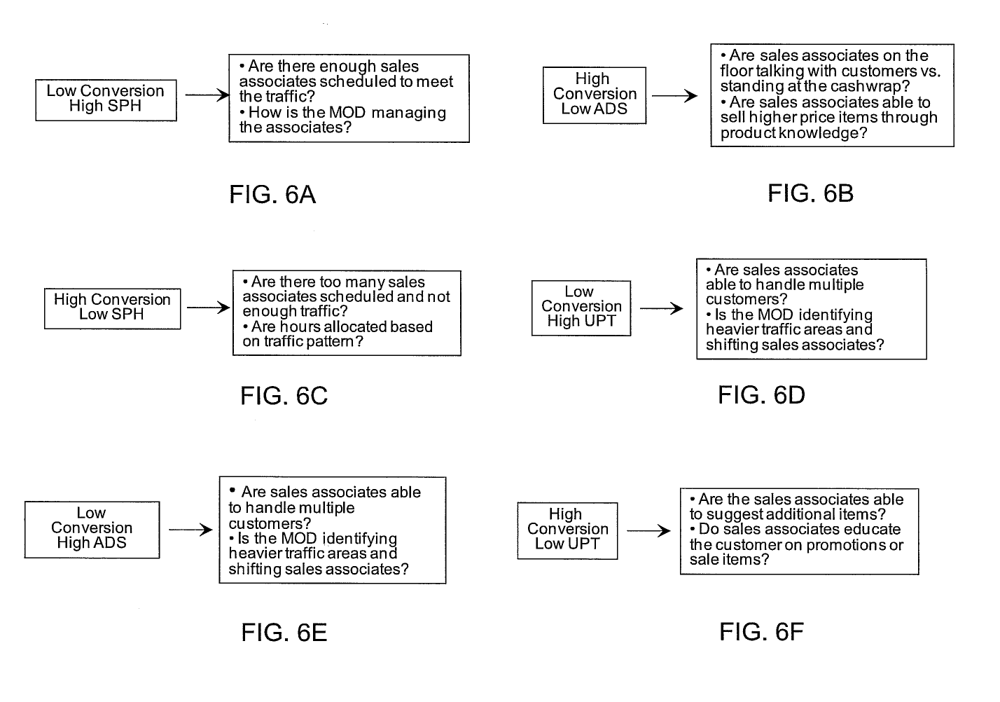

At step 503, the optimization module 104 may adjust thresholds based on a forecasting variable to determine the recommended actions. For example, a threshold or goal for a metric to determine whether a metric is satisfactory or not may be adjusted based on the current state of the forecasting variable. Current state may be a measurement or value for a forecasting variable, such as the unemployment rate published by the federal government. For example, if the unemployment rate is high, then it may lower the threshold for determining what is considered acceptable sales revenue. If the unemployment rate is low, then it may increase the threshold for determining what is considered acceptable sales revenue. An example, is described with respect to FIG. 6B.

FIGS. 6A-F illustrate examples of conditions that may be identified by the optimization module 104 and corresponding recommended actions that may be identified by the optimization module 104 in response to the conditions. For example, FIG. 6A shows that if there is a low conversion percentage but high sales per hour (SPH), then the recommended actions are to determine whether there were sufficient sales associates scheduled to meet the customer traffic and to determine how well the manager on duty (MOD) is managing the sales associates. To determine whether a conversion percentage or other metric is low or high, the optimization module 104 may compare the metrics to predetermined thresholds, which may be the goals for the metrics.

FIG. 6B shows that if conversion percentage is high but the average dollar amount per sale (ADS) is low, then the recommended actions are to determine whether the sales associates are engaging customers and to determine whether the sales associates are able to sell higher priced items through product knowledge. ADS may be determined as total net sales/number of transactions. If the optimization module 104 determines that the forecasting variable of unemployment rate may be considered as a factor, then the optimization module 104 may adjust a threshold. For example, customers may be purchasing lower priced items due to a recession, so the threshold is lowered for determining that the ADS is low. If unemployment rate improves, then the threshold may be raised.

FIG. 6C shows that if conversion percentage is high and SPH is low, then the recommended actions may include determining whether there are too many sales associates scheduled and not enough traffic, and determining whether sales associates work hours are allocated based on customer traffic patterns. FIG. 6D shows that if conversion percentage is low and number of item or units sold per transaction (UPT) is high, the recommended actions may include determining whether there are a sufficient amount of sales associates to handle multiple customers and determining whether the MOD is identifying heavier traffic areas and shifting sales associates accordingly. FIG. 6E shows that if conversion percentage is low and ADS is high, the recommended actions may include determining whether there are a sufficient amount of sales associates to handle multiple customers and determining whether the MOD is identifying heavier traffic areas and shifting sales associates accordingly. FIG. 6F shows that if conversion percentage is high but UPT is low, then the recommended actions may include determining whether the sales associates are able to suggest additional items and determining whether the sales associates are educating the customers on promotions and sale items.

FIG. 7 shows a computer system 700 that may be used as a hardware platform for the system 100. The computer system 700 may execute one or more of the steps, methods, and functions described herein that may be embodied as software stored on one or more computer readable mediums, which may be non-transitory, such as hardware storage devices.

The computer system 700 includes a processor 702 or processing circuitry that may implement or execute software instructions performing some or all of the methods, functions and other steps described herein. The modules in the system 100 may include software executed by the processor 702. Commands and data from the processor 702 are communicated over a communication bus 704. The computer system 700 also includes a computer readable storage device 703, such as random access memory (RAM), where the software and data for processor 702 may reside during runtime. The storage device 703 may also include non-volatile data storage. The computer system 700 may include a network interface 705 for connecting to a network. It will be apparent to one of ordinary skill in the art that other known electronic components may be added or substituted in the computer system 700. Also, the system 100 may be implemented on a distributed computing system, such as a cloud. For a distributed computing system, the services provided by the system 100 to multiple users may be performed by multiple computer systems.

While the embodiments have been described with reference to examples, those skilled in the art will be able to make various modifications to the described embodiments without departing from the scope of the claimed embodiments. For example, one or more of the embodiments are generally described with respect to improving sales metrics by way of example, but the embodiments may be used to improve other types of metrics for areas other than sales.

What is claimed is:

1. A sales optimization system comprising:
a forecasting module, executed by a processor, to determine forecasts for sales metrics, including identifying forecasting variables relevant to the forecasts, determining quantifications for the identified forecasting variables based on estimation of an amount of impact the forecasting variables have on the sales metrics, and determining the forecasts for the sales metrics based on the quantifications;
an optimization module to determine recommended actions for achieving sales goals by determining factors estimated to have impacted the sales metrics, determining whether one or more of the factors have mappings to recommended actions, and if the factors have the mappings to the recommended actions, selecting the recommended actions; and
a user interface to generate scorecards indicating actual vales for the sales metrics, forecasts for the sales metrics, and the selected recommended actions.

2. The sales optimization system of claim 1, wherein the optimization module determines the factors estimated to have impacted the sales metrics by determining goals for the sales metrics, determining the sales metrics that failed to satisfy the goals and selecting the factors for the sales metrics determined to have failed to satisfy the goals.

3. The sales optimization system of claim 2, wherein the goals comprise an upper and lower threshold for one of the sales metric, and the upper or lower threshold is modified based on a current state of one of the forecasting variables associated with the one of the sales metrics.

4. The sales optimization system of claim 1, wherein the factors are determined from store profiles, customer profiles, or locations of the stores or customers.

5. The sales optimization system of claim 1, wherein at least one of the factors is determined from a sales model, and the sales model specifies a plan for sales associates to follow to maximize the sales metrics.

6. The sales optimization system of claim 1, wherein the quantifications determined by the forecasting module comprise weights or ranges for the forecasting variables.

7. The sales optimization system of claim 1, wherein the sales metrics comprise at least some of number of customers, conversion percentage, average order size, and sales revenue.

8. The sales optimization system of claim 1, wherein the forecasting variables are variables independent of the sales metrics and are operable to impact the sales metrics.

9. The sales optimization system of claim 1, wherein the scorecards include daily reports, and each daily report includes, for the previous day, the sales metrics, the forecasts and the recommended actions.

10. The sales optimization system of claim 1, wherein the recommended actions comprise actions to be implemented to improve the sales metrics.

11. The sales optimization system of claim 1, wherein the recommended actions comprise at least one of staffing modifications, training, and sales force motivation activities.

12. A method for optimizing sales metrics, the method comprising:
identifying forecasting variables relevant to forecasts for sales metrics;
determining quantifications for the identified forecasting variables based on estimation of an amount of impact the forecasting variables have on the sales metrics;
determining, by a processor, the forecasts for the sales metrics based on the quantifications;
determining factors estimated to have impacted the sales metrics;
determining whether one or more of the factors have mappings to recommended actions;
if the factors have the mappings to the recommended actions, selecting the recommended actions; and
presenting the recommended actions via a user interface

13. The method of claim 12, wherein determining the factors estimated to have impacted the sales metrics comprises:
determining goals for the sales metrics;
determining the sales metrics that failed to satisfy the goals; and
selecting the factors for the sales metrics determined to have failed to satisfy the goals.

14. The method of claim 13, wherein the goals comprise an upper and lower threshold for one of the sales metric, and the method comprises:
modifying the upper or lower threshold based on a current state of one of the forecasting variables associated with the one of the sales metrics.

15. The method of claim 12, wherein the factors are determined from store profiles, customer profiles, or locations of the stores or customers.

16. The method of claim 12, wherein the quantifications determined by the forecasting module comprise weights or ranges for the forecasting variables.

17. The method of claim 12, wherein the sales metrics comprise at least some of number of customers, conversion percentage, average order size, and sales revenue.

18. The method of claim 12, wherein the recommended actions comprise actions to be implemented to improve the sales metrics.

19. A non-transitory computer readable including machine readable instructions that when executed by a processor perform a method comprising:
identifying forecasting variables relevant to forecasts for sales metrics;
determining quantifications for the identified forecasting variables based on estimation of an amount of impact the forecasting variables have on the sales metrics;
determining, by a processor, the forecasts for the sales metrics based on the quantifications;
determining factors estimated to have impacted the sales metrics;
determining whether one or more of the factors have mappings to recommended actions;
if the factors have the mappings to the recommended actions, selecting the recommended actions; and
presenting the recommended actions via a user interface

20. The computer readable medium of claim 19, wherein determining the factors estimated to have impacted the sales metrics comprises:
determining goals for the sales metrics;
determining the sales metrics that failed to satisfy the goals; and
selecting the factors for the sales metrics determined to have failed to satisfy the goals.
